(19) United States
(12) Patent Application Publication
(10) Pub. No.: US 2024/0090070 A1
(43) Pub. Date: Mar. 14, 2024

(54) COMMUNICATION APPARATUS, AND COMMUNICATION METHOD

(71) Applicants: DENSO CORPORATION, Kariya-city (JP); TOYOTA JIDOSHA KABUSHIKI KAISHA, Toyota-shi (JP)

(72) Inventors: Tomoyuki YAMAMOTO, Kariya-city (JP); Hideaki TAKAHASHI, Kariya-city (JP)

(21) Appl. No.: 18/515,888

(22) Filed: Nov. 21, 2023

Related U.S. Application Data
(63) Continuation of application No. PCT/JP2022/021290, filed on May 24, 2022.

(30) Foreign Application Priority Data
May 25, 2021 (JP) 2021-087603

(51) Int. Cl. H04W 76/20; H04W 68/02; H04W 76/38

(52) U.S. Cl. CPC H04W 76/20; H04W 68/02; H04W 76/38

(57) ABSTRACT

A communication apparatus configured to communicate with a plurality of networks by using a plurality of subscriber identity modules comprises a communicator and a controller. The communicator is configured to receive, from a network included in the plurality of networks, first information for setting a value of a timer relating to transition of a radio resource management (RRC) connected state, and transmit, to the network, second information to be used to indicate an RRC state transitioning from the RRC connected state. The second information can indicate an RRC inactive state as the RRC state. The controller is configured to start the timer on the basis of transmission of the second information, and cause the RRC state to transition to an RRC idle state on the basis of expiration of the timer.

### CROSS-REFERENCE TO RELATED APPLICATIONS

The present application is a continuation application of international Patent Application No. PCT/JP2022/021290, filed on May 24, 2022, which designated the U.S., and claims the benefit of priority of Japanese Patent Application No. 2021-087603, filed on May 25, 2021, the entire contents of which are incorporated herein by reference.

### TECHNICAL FIELD

The present disclosure relates to a communication apparatus, and a communication method used in a mobile communication system.

### BACKGROUND ART

In Release 17 of 3GPP (3rd Generation Partnership Project) (registered trademark. The same applies hereinafter), which is a mobile communication system standardization project, a work item has been launched for designing a function for a communication apparatus (hereinafter, referred to as a user equipment as appropriate) equipped with a plurality of subscriber identity modules to perform data communication while existing in networks of a plurality of communication operators. Currently, a mechanism in which a user equipment existing in a plurality of networks receives paging is not specified in a standard specification and is dependent on implementation of the user equipment. Thus, a method of receiving paging from a plurality of networks in cooperation with each network has been studied in the field of 3GPP standardization.

Here, in a case where during communication in an RRC connected state in one network (hereinafter, a “first network”), communication with the other network (hereinafter, a “second network”) is prioritized over the communication with the first network in a case where a paging message from the second network is received, it has been studied that a user equipment temporarily transmits to the first network, a switching notification indicating transition (that is, leaving) from the RRC connected state in the first network in order to switch the communication from the first network to the second network (see, for example, Non Patent Literature 1). As a result of the user equipment being no longer in the RRC connected state in the first network, occurrence of unnecessary communication with the first network can be prevented during the communication with the second network.

In addition to a case of the transition from the RRC connected state to an RRC idle state in the first network, a case of the transition from the RRC connected state to an RRC inactive state in which context information of the user equipment is stored in the first network is also studied (see, for example, Non Patent Literature 2).

The user equipment can maintain the RRC inactive state in the first network during communication with the second network by transmitting to the first network, a switching notification indicating that transition from the RRC connected state to the RRC inactive state is expected in the first network. As a result, it is possible to simplify procedure for starting the communication with the first network after end of the communication with the second network.

Note that in order to transition to the RRC inactive state in the first network, the user equipment needs to receive from the first network, configuration information necessary for transition to the RRC inactive state.

### CITATION LIST

### Non Patent Literature

Non Patent Literature 1: 3GPP Contribution “R1-2100474”
Non Patent Literature 2: 3GPP Contribution “R1-2104301”

### SUMMARY OF INVENTION

A communication apparatus according to a first aspect is configured to communicate with a plurality of networks by using a plurality of subscriber identity modules. The communication apparatus comprises a communicator and a controller. The communicator is configured to receive, from a network included in the plurality of networks, first information for setting a value of a timer relating to transition of a radio resource management (RRC) connected state, and transmit, to the network, second information to be used to indicate an RRC state transitioning from the RRC connected state. The second information can indicate an RRC inactive state as the RRC state. The controller is configured to start the timer on a basis of transmission of the second information, and cause the RRC state to transition to an RRC idle state on a basis of expiration of the timer.

A communication method according to the second aspect is executed in a communication apparatus configured to communicate with a plurality of networks by using a plurality of subscriber identity modules. The communication method comprising the steps of: receiving, from a network included in the plurality of networks, first information for setting a value of a timer relating to transition of a radio resource management (RRC) connected state; and transmitting, to the network, second information to be used to indicate an RRC state transitioning from the RRC connected state. The second information can indicate an RRC inactive state as the RRC state. The communication method further comprises the steps of: starting the timer on the basis of transmission of the second information; and causing the RRC state to transition to an RRC idle state on the basis of expiration of the timer.

### BRIEF DESCRIPTION OF DRAWINGS

FIG. 1 is a view illustrating a configuration example of a mobile communication system according to an embodiment.

FIG. 2 is a view illustrating a configuration example of a protocol stack of the mobile communication system according to the embodiment.

FIG. 3 is a view illustrating a configuration example of a user equipment (UE) according to the embodiment.

FIG. 4 is a view illustrating a configuration example of a base station of a first network according to the embodiment.

FIG. 5 is a view illustrating a first operation example of the embodiment.

FIG. 6 is a view illustrating a second operation example of the embodiment.

FIG. 7 is a view illustrating a third operation example of the embodiment.

FIG. 8 is a view illustrating a fourth operation example of the embodiment.

FIG. 9 is a view illustrating a fifth operation example of the embodiment.

FIG. 10 is a view illustrating a sixth operation example of the embodiment.

FIG. 11 is a view illustrating a seventh operation example of the embodiment.

### DESCRIPTION OF EMBODIMENTS

A mobile communication system according to an embodiment will be described with reference to the drawings. In the description of the drawings, the same or similar parts are denoted by the same or similar reference numerals.

A case will be assumed where, in a case where a user equipment gives priority to communication with a second network over communication with a first network, a switching notification indicating that transition from an RRC connected state to an RRC inactive state is expected in the first network is transmitted from the user equipment to the first network.

In a case where the user equipment cannot receive a response to the switching notification from the first network, the user equipment cannot autonomously transition to the RRC inactive state without receiving necessary configuration information from the first network. Thus, there is a possibility that the user equipment continues to wait for a response from the first network. This causes a problem that switching of communication from the first network to the second network is delayed although priority is given to communication with the second network over communication with the first network.

It is therefore an object of the present disclosure to provide a communication apparatus and a communication method that prevent a delay in switching of communication from a first network to a second network in a case where transition to an RRC inactive state is expected in the first network.

### Embodiment

(System Configuration)

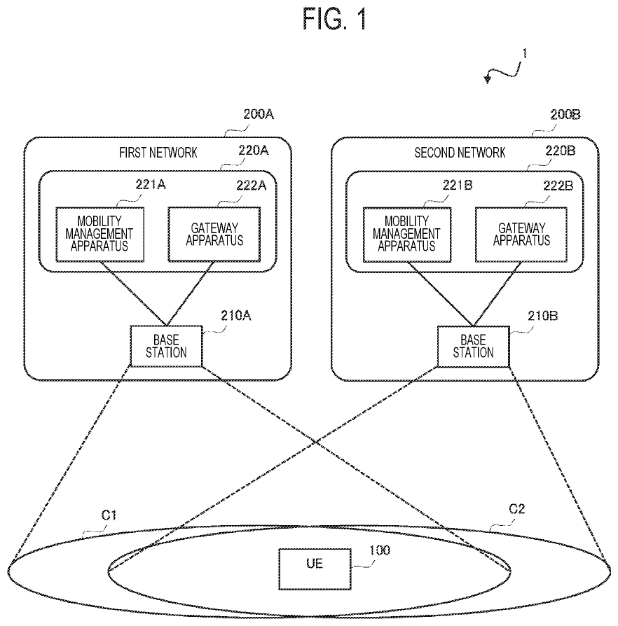

A configuration of a mobile communication system 1 according to the embodiment will be described with reference to FIG. 1. Hereinafter, an example in which a mobile communication system 1 is a fifth generation system (5G/NR: New Radio) in the 3GPP standard will be mainly described, but a fourth generation system (4G/LTE: Long Term Evolution) system and/or a sixth generation system may be at least partially applied to the mobile communication system 1.

As illustrated in FIG. 1, the mobile communication system 1 according to the embodiment includes a user equipment (UE (User Equipment)) 100, a first network 200A, and a second network 200B.

The UE 100 is an example of a communication apparatus. The UE 100 may be a mobile radio communication apparatus. The UE 100 may be an apparatus used by a user. For example, the UE 100 is a mobile phone terminal (including a smartphone), a tablet terminal, a laptop PC, a communication module (including a communication card or a chipset), a sensor or equipment provided in the sensor, a vehicle or equipment provided in the vehicle (for example, a vehicle UE), or an aerial vehicle or equipment provided in the aerial vehicle (for example, an aerial UE).

The UE 100 is a multi-SIM device corresponding to a plurality of subscriber identity modules (SIM (Subscriber Identity Module)). The UE 100 communicates with the plurality of networks by using a plurality of SIMs. Hereinafter, an example in which the UE 100 supports two SIMs will be mainly described; however, the UE 100 may support three or more SIMs. “Supporting a plurality of SIMs” means that the UE 100 has an ability to handle a plurality of SIMs, and the UE 100 may not be necessarily equipped with the plurality of SIMs. Such a UE 100 may be referred to as a “UE supporting a plurality of SIMs”. Note that the SIM is not limited to a card type SIM (so-called a SIM card), and may be an embedded SIM (so-called an eSIM) that is integrated in the UE 100 in advance. The SIM may be referred to as a USIM (Universal Subscriber Identity Module).

The first network 200A is a network associated with one SIM of the UE 100. The second network 200B is a network associated with the other SIM of the UE 100. It is assumed that the UE 100 has performed location registration in the first network 200A using one SIM and performed location registration in the second network 200B using the other SIM. That is, the UE 100 exists in each of the first network 200A and the second network 200B. The first network 200A and the second network 200B may be networks of different communication operators. However, the first network 200A and the second network 200B may be networks of the same communication operators. Different PLMN (Public Land Mobile Network) IDs may be allocated to the first network 200A and the second network 200B.

The first network 200A includes a base station 210A constituting a radio access network and a core network 220A. The core network 220A includes a mobility management apparatus 221A and a gateway apparatus 222A as core network apparatuses. Similarly, the second network 200B includes a base station 210B constituting a radio access network and a core network 220B. The core network 220B includes a mobility management apparatus 221B and a gateway apparatus 222B as core network apparatuses. Hereinafter, the base stations 210A and 200B will be simply referred to as a base station 210 in a case where they are not distinguished, the mobility management apparatuses 221A and 221B will be simply referred to as a mobility management apparatus 221 in a case where they are not distinguished, and the gateway apparatuses 222A and 222B will be simply referred to as a gateway apparatus 222 in a case where they are not distinguished.

The base station 210 is a radio communication apparatus that performs radio communication with the UE 100. The base station 210 manages one or a plurality of cells. The base station 210 performs radio communication with the UE 100 that has established a connection with its cell in a radio resource control (RRC) layer. The base station 210 has a radio resource management (RRM) function, a routing function of user data (hereinafter, simply referred to as “data”), a measurement control function for mobility control and scheduling, and the like. The “cell” is used as a term indicating a minimum unit of a radio communication area. The “cell” is also used as a term indicating a function or a resource that performs radio communication with the UE 100. One cell belongs to one carrier frequency. FIG. 1 illustrates an example in which the base station 210A manages a cell C1 and the base station 210B manages a cell C2. The UE 100 is located in an overlapping region of the cell C1 and the cell C2.

The base station 210 may be a gNB, which is a 5G/NR base station, or an eNB, which is a 4G/LTE base station. Hereinafter, an example in which the base station 210 is a gNB will be mainly described. The function of the base station 210 may be divided into a CU (Central Unit) and a DU (Distributed Unit). The base station 210 may be a relay node such as an IAB (Integrated Access and Backhaul) node.

The mobility management apparatus 221 is an apparatus supporting a control plane, and is an apparatus that performs various mobility management for the UE 100. The mobility management apparatus 221 communicates with the UE 100 using NAS (Non-Access Stratum) signaling and manages information on a tracking area in which the UE 100 exists. The mobility management apparatus 221 performs paging through the base station 210 to notify the UE 100 of an incoming call. The mobility management apparatus 221 may be an AMF (Access and Mobility Management Function) in 5G/NR or a MME (Mobility Management Entity) in 4G/LTE.

The gateway apparatus 222 is an apparatus supporting a user plane and performs transfer control of data of the UE 100. The gateway apparatus 222 may be an UPF (User Plane Function) in 5G/NR or a S-GW (Serving Gateway) in 4G/LTE.

(Configuration Example of Protocol Stack)

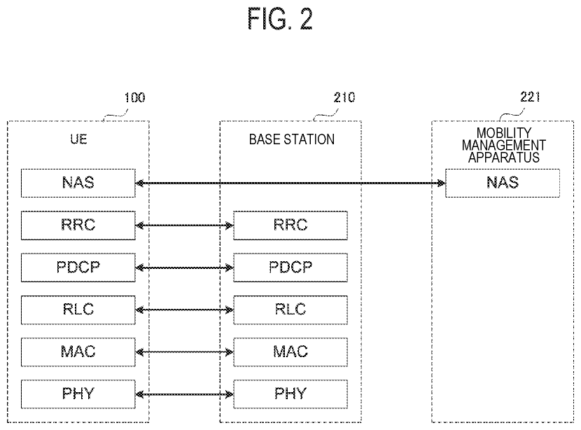

A configuration example of a protocol stack of the mobile communication system 1 will be described with reference to FIG. 2. As illustrated in FIG. 2, a protocol of a radio section between the UE 100 and the base station 210 includes a physical (PHY) layer, a MAC (Medium Access Control) layer, a RLC (Radio Link Control) layer, a PDCP (Packet Data Convergence Protocol) layer, and a RRC (Radio Resource Control) layer.

The PHY layer performs encoding/decoding, modulation/demodulation, antenna mapping/demapping, and resource mapping/demapping. Data and control information are transmitted via a physical channel between the PHY layer of the UE 100 and the PHY layer of the base station 210.

The MAC layer performs data priority control, retransmission processing by hybrid ARQ (HARQ), a random access procedure, and the like. Data and control information are transmitted via a transport channel between the MAC layer of the UE 100 and the MAC layer of the base station 210. The MAC layer of the base station 210 includes a scheduler. The scheduler determines uplink and downlink transport formats (transport block size, modulation and coding scheme (MCS)) and allocated resources to the UE 100.

The RLC layer transmits data to the RLC layer on the reception side using the functions of the MAC layer and the PHY layer. Data and control information are transmitted via a logical channel between the RLC layer of the UE 100 and the RLC layer of the base station 210.

The PDCP layer performs header compression/decompression and encryption/decryption.

A SDAP (Service Data Adaptation Protocol) layer may be provided as an upper layer of the PDCP layer. The SDAP (Service Data Adaptation Protocol) layer performs mapping between an IP flow, a unit in which a core network performs QoS control, and a radio bearer, a unit in which an AS (Access Stratum) performs QoS control.

The RRC layer controls a logical channel, a transport channel, and a physical channel according to establishment, reestablishment, and release of the radio bearer. RRC signaling for various configurations is transmitted between the RRC layer of the UE 100 and the RRC layer of the base station 210. In a case where there is an RRC connection between the RRC of the UE 100 and the RRC of the base station 210, the UE 100 is in an RRC connected state. In a case where there is no RRC connection between the RRC of the UE 100 and the RRC of the base station 210, the UE 100 is in an RRC idle state. In a case where the RRC connection between the RRC of the UE 100 and the RRC of the base station 210 is suspended, the UE 100 is in an RRC inactive state.

The NAS layer located above the RRC layer performs session management and mobility management of the UE 100. NAS signaling is transmitted between the NAS layer of the UE 100 and the NAS layer of the mobility management apparatus 221.

A mode (NAS state) in a NAS layer of a UE 100 includes an idle mode and a connected mode. In the connected mode, context information of the UE 100 is stored in the network, and in the idle mode, context information of the UE 100 is not stored in the network. In a case where the UE 100 is in the connected mode, the UE 100 is in the RRC connected state or the RRC inactive state. In a case where the UE 100 is in idle mode, the UE 100 is in an RRC idle state.

The mode in the NAS layer may be a 5G mobility management (5GMM) mode. In this mode, the connected mode may be a 5GMM-connected mode, and the idle mode may be a 5GMM-idle mode.

Note that the UE 100 has an application layer and the like in addition to the protocol of the radio interface.

(Configuration Example of UE)

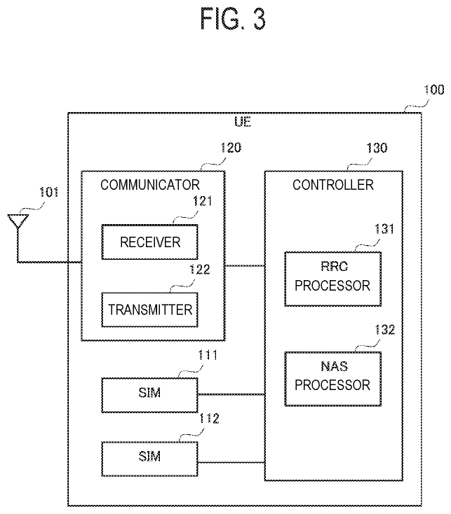

A configuration example of the UE 100 will be described with reference to FIG. 3. As illustrated in FIG. 3, the UE 100 includes an antenna 101, a SIM 111, a SIM 112, a communicator 120, and a controller 130. The antenna 101 may be provided outside the UE 100. The SIM 111 and the SIM 112 are SIM cards or eSIMs.

The SIM 111 stores subscriber information and configuration information necessary for the UE 100 to communicate with the first network 200A. The SIM 111 stores identification information of the UE 100 in the first network 200A, for example, a telephone number, an IMSI (International Mobile Subscriber Identity), and the like. The SIM 111 corresponds to the first subscriber information module. The UE 100 communicates with the first network 200A by using the SIM 111.

The SIM 112 stores subscriber information and configuration information necessary for the UE 100 to communicate with the second network 200B. The SIM 112 stores identification information of the UE 100 in the second network 200B, for example, a telephone number, an IMSI, and the like. The SIM 112 corresponds to a second subscriber information module. The UE 100 communicates with the second network 200B by using the SIM 112.

The communicator 120 performs radio communication with the first network 200A and radio communication with the second network 200B via the antenna 101 under the control of the controller 130. The communicator 120 may include only one receiver (RX: Receiver) 121. In this case, the communicator 120 cannot simultaneously perform reception from a first network 200A and reception from a second network 200B. The communicator 120 may include only one transmitter (TX: Transmitter) 122. However, the communicator 120 may include a plurality of transmitters 122. The receiver 121 converts a radio signal received by the antenna 101 into a reception signal that is a baseband signal, performs signal processing on the reception signal, and outputs the reception signal to the controller 130. The transmitter 122 performs signal processing on a transmission signal that is a baseband signal output by the controller 130, converts the transmission signal into a radio signal, and transmits the radio signal from the antenna 101.

The controller 130 controls the communicator 120 and performs various types of control in the UE 100. The controller 130 controls communication with the first network 200A using the SIM 111 and controls communication with the second network 200B using the SIM 112. The controller 130 includes at least one processor and at least one memory. The memory stores a program executed by the processor and information used for processing by the processor. The memory may include at least one of a ROM (Read Only Memory), an EPROM (Erasable Programmable Read Only Memory), an EEPROM (Electrically Erasable Programmable Read Only Memory), a RAM (Random Access Memory), and a flash memory. The processor may include a digital signal processor (DSP) that performs digital processing on a digital signal and a central processing unit (CPU) that executes a program. Note that a part of the memory may be provided in the communicator 120. In addition, the DSP may be provided in the communicator 120.

The controller 130 includes a RRC processor 131 and a NAS processor 132. The RRC processor 131 performs processing in the processing of the RRC layer. The NAS processor 132 performs processing in the processing of the NAS layer, which is a layer higher than the RRC layer. Note that the RRC processor 131 and the NAS processor 132 may be configured by one processor or may be configured by a plurality of processors.

The UE 100 configured as described above communicates with the first network 200A by using the SIM 111, and communicates with the second network 200B by using the SIM 112. The communicator 120 receives a paging message from the second network 200B during communication in the RRC connected state in the first network 200A. In a case where a response to an inactive switching notification is not received from the first network 200A within a designated period since the inactive switching notification indicating that the transition to the RRC inactive state is expected in the first network 200A has been transmitted to the first network 200A in response to reception of the paging message, a controller 130 performs control to transition from the RRC connected state to the RRC idle state in the first network 200A. Accordingly, the UE 100 does not continue to wait for a response to the inactive switching notification from the first network 200A after the designated period has elapsed, so that it is possible to prevent a delay in switching of communication from the first network 200A to the second network 200B.

Furthermore, the controller 130 may store a reception timer that clocks a designated period. In a case where a response to the inactive switching notification is received from the first network 200A before the reception timer expires, the controller 130 may perform control to transition from the RRC connected state to the RRC inactive state in the first network 200A. In a case where a response to the inactive switching notification is not received from the first network 200A until the reception timer expires, the controller 130 may perform control to transition from the RRC connected state to the RRC idle state in the first network 200A. As a result, in a case where a response to the inactive switching notification is received before the reception timer expires, the UE 100 can start control to transition to the RRC inactive state before the designated time elapses and does not keep waiting for a response to the inactive switching notification from the first network 200A after the designated period has elapsed. It is therefore possible to prevent a delay in switching of communication from the first network 200A to the second network 200B.

In addition, in a case where a response to the idle switching notification is not received from the first network 200A within a designated period since the idle switching notification indicating that the transition to the RRC idle state is expected in the first network 200A has been transmitted to the first network 200A in response to reception of the paging message, the controller 130 may transition from the RRC connected state to the RRC idle state in the first network 200A. The reception timer may be the same as a timer that clocks a designated period after the idle switching notification has been transmitted. As a result, the UE 100 does not need to manage a plurality of timers, so that load of the UE 100 can be reduced.

In addition, in a case where a response to the idle switching notification is not received from the first network 200A within a designated period since the idle switching notification indicating that the transition to the RRC idle state is expected in the first network 200A has been transmitted to the first network 200A in response to reception of the paging message, the controller 130 may transition from the RRC connected state to the RRC idle state in the first network 200A. The reception timer may be different from a timer that clocks a designated period after the idle switching notification has been transmitted. As a result, it is possible to change a response waiting period (designated period) between a case where the inactive switching notification is transmitted and a case where the idle switching notification is transmitted.

Further, the controller 130 may include an RRC processor 131 and a NAS processor 132. The NAS processor 132 performs control to transmit an inactive switching notification to the first network 200A. The NAS processor 132 may start a reception timer stored by the NAS processor 132 in response to transmission of the inactive switching notification. As a result, the NAS processor 132 can transmit the switching notification and start the reception timer, and thus, exchange between the RRC processor 131 and the NAS processor 132 can be reduced, so that processing load of the UE 100 can be reduced.

In addition, the NAS processor 132 may receive a timer value indicating a designated period to be set in the reception timer from the first network 200A. As a result, the first network 200A can configure the timer value, and thus, a period until transition from the RRC connected state in the first network 200A can be flexibly controlled.

In addition, the NAS processor 132 may provide a notification for starting transition to the RRC idle state to the RRC processor 131 in response to expiration of the reception timer. As a result, the RRC processor 131 can appropriately start transition to the RRC idle state.

Further, the controller 130 may include an RRC processor 131 and a NAS processor 132. The RRC processor 131 may store a reception timer. As a result, the RRC processor 131 can start transition to the RRC idle state in response to expiration of the reception timer without notification from the NAS processor 132. Exchange between the RRC processor 131 and the NAS processor 132 can be reduced, so that processing load of the UE 100 can be reduced.

In addition, the RRC processor 131 may perform control to transmit an inactive switching notification to the first network 200A. The RRC processor 131 may start the reception timer in response to transmission of the inactive switching notification. Transmission of the switching notification and starting of the reception timer can be performed in the RRC processor 131, and thus, exchange between the RRC processor 131 and the NAS processor 132 can be reduced, so that processing load of the UE 100 can be reduced.

In addition, the RRC processor 131 may receive a timer value indicating a designated period to be set in the reception timer from the first network 200A. As a result, the first network 200A can configure the timer value, and thus, a period until transition from the RRC connected state in the first network 200A can be flexibly controlled.

Note that an operation of a functional unit (specifically, at least one of the antenna 101, the SIM 111, the SIM 112, the communicator 120, and the controller 130 (the RRC processor 131 and the NAS processor 132)) included in the UE 100 may be described as the operation of the UE 100.

(Configuration Example of Base Station)

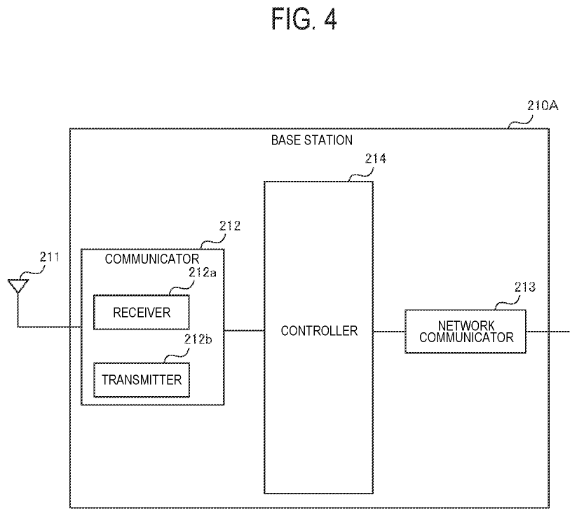

A configuration example of the base station 210A of the first network 200A will be described with reference to FIG. 4. Since the base station 210B of the second network 200B also has the same configuration as the base station 210A, the description thereof will be omitted. As illustrated in FIG. 4, the base station 210A includes an antenna 211, a communicator 212, a network communicator 213, and a controller 214.

The communicator 212 performs communication with the UE 100 via the antenna 211 under the control of the controller 214. The communicator 212 includes a receiver 212a and a transmitter 212b. The receiver 212a converts a radio signal received by the antenna 211 into a reception signal that is a baseband signal, performs signal processing on the reception signal, and outputs the reception signal to the controller 214. The transmitter 212b performs signal processing on a transmission signal that is a baseband signal output by the controller 214, converts the transmission signal into a radio signal, and transmits the radio signal from the antenna 211.

The network communicator 213 is connected to the core network 220A. The network communicator 213 performs network communication with the mobility management apparatus 221A and the gateway apparatus 222A under the control of the controller 214.

The controller 214 controls the communicator 212 and performs various types of control in the base station 210A. The controller 214 includes at least one processor and at least one memory. The memory stores a program executed by the processor and information used for processing by the processor. The memory may include at least one of a ROM, an EPROM, an EEPROM, a RAM, and a flash memory. The processor may include a digital signal processor (DSP) that performs digital processing on a digital signal and a central processing unit (CPU) that executes a program. Note that a part of the memory may be provided in the communicator 212. In addition, the DSP may be provided in the communicator 212.

Note that an operation of a functional unit (specifically, at least one of the antenna 211, the communicator 212, the network communicator 213, and the controller 214) included in the base station 210A may be described as an operation of the base station 210A.

(Operation of Mobile Communication System)

The operation of the mobile communication system 1 will be described.

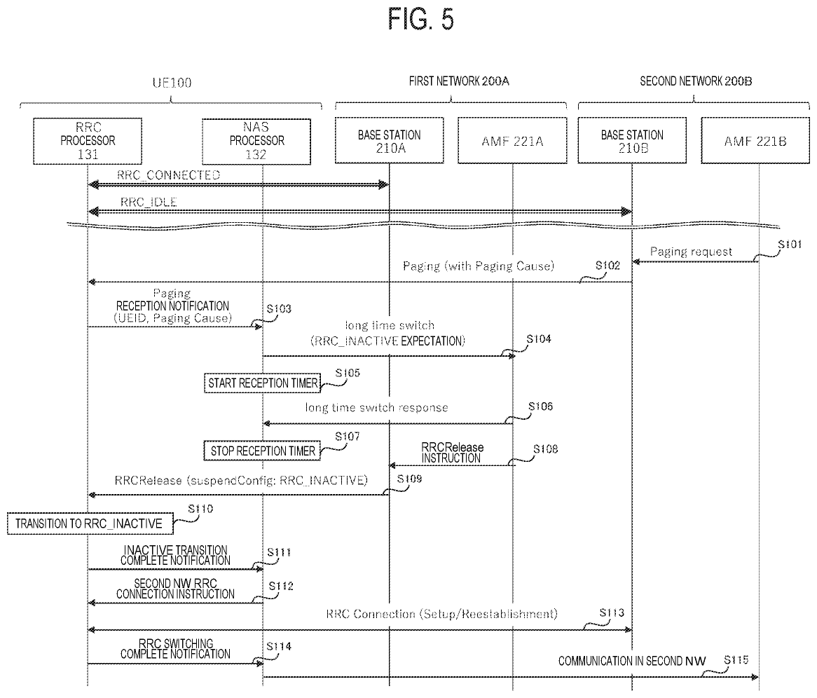

A first operation example of the mobile communication system 1 will be described with reference to FIG. 5. The first operation example describes a case where the UE 100 receives a response to the switching notification before the reception timer expires.

In the operation example illustrated in FIG. 5, the UE 100 exists in a cell C1 managed by the base station 210B of the first network 200A and exists in a cell C2 managed by the base station 210B of the second network 200B.

As illustrated in FIG. 5, the UE 100 is in the RRC connected state in the first network and is in communication in the first network. For example, the UE 100 is provided with a service such as a voice call from the first network 200A. Note that “in communication in the first network” means that the UE 100 may be at least in the RRC connected state in the first network and does not necessarily need to continuously exchange data with the first network.

As illustrated in FIG. 5, the UE 100 is in the RRC idle state in the second network 200B. Note that the UE 100 may be in the RRC inactive state in the second network 200B. The UE 100 monitors paging from the second network 200B while maintaining the RRC connected state in the first network 200A. The UE 100 can monitor paging during a communication interruption period with the first network 200A, for example.

Note that the description will proceed on the assumption that each of the mobility management apparatus 221A that is a core network apparatus of the first network 200A and the mobility management apparatus 221B that is a core network apparatus of the second network 200B is an AMF.

Hereinafter, the RRC processor 131 and the NAS processor 132 perform communication (specifically, transmission and reception/notification of messages, and the like) with the second network 200B via the communicator 120, but for convenience of description, the description of communication via the communicator 120 will be omitted as appropriate. In addition, an AMF 221B communicates (transmission and reception/notification of messages and the like) with the UE 100 (specifically, the NAS processor 132) via the base station 210B, but for convenience of description, the description of the communication via the base station 210B will be omitted as appropriate.

Step S101:

The AMF 221B transmits a paging request (Paging request) for requesting transmission of paging addressed to the UE 100 to the base station 210B. A network communicator 213 of the base station 210B receives the paging request.

The paging request may include paging cause information (Paging Cause) indicating a cause of paging. The paging cause information may indicate, for example, whether or not a cause of paging is a voice call.

Step S102:

A communicator 212 of the base station 210B transmits a paging message (Paging) addressed to the UE 100 in response to reception of the paging request. The communicator 120 of the UE 100 receives the paging message. Thus, the communicator 120 receives the paging message from the second network 200B during communication in the RRC connected state in the first network 200A.

The paging message is used for notification to one or more UEs 100. The paging message is a message in the RRC layer. The paging message includes, for example, an ID of the UE 100. More specifically, for example, the paging message includes a list of paging records, and one paging record in the list includes the ID of the UE 100. For example, the ID is the 5G-S-TMSI or the full I-RNTI (Inactive Radio Network Temporary Identifier) of the UE 100.

The paging message may include the paging cause information. The paging cause information may be associated with an ID of the UE 100, for example.

In a case where the paging message includes the ID of the UE 100 and the UE 100 is in the RRC inactive state with respect to the second network 200B while communicating with the first network 200A, the RRC processor 131 can execute processing of step S103.

In a case where the paging message includes the ID of the UE 100 and the UE 100 is not in communication with the first network 200A, for example, in a case where the UE 100 is in the RRC idle state or the RRC inactive state with respect to the first network 200A, the RRC processor 131 may perform specified processing when the paging message is received without performing the processing of step S103.

Step S103:

The RRC processor 131 provides a paging reception notification to the NAS processor 132. The NAS processor 132 receives the paging reception notification. The paging reception notification is for notifying that the UE 100 has received paging. The RRC processor 131 may indicate to the NAS processor 132 that the paging message is received when the UE 100 is in an RRC inactive state using a paging reception notification.

The paging reception notification may include the paging cause information. Note that, for example, in a case where the UE 100 is in the RRC idle state, the paging reception notification may include an identifier (UE ID) of the UE 100.

The NAS processor 132 determines priority between communication with the first network and communication with the second network. Specifically, the NAS processor 132 determines which of communication with the first network 200A and communication with the second network 200B corresponding to paging is prioritized (or which is preferred). Note that the NAS processor 132 may determine which of connection with the first network and connection with the second network is more important.

The NAS processor 132 may determine which of communication with the first network 200A and communication with the second network 200B corresponding to paging is prioritized on the basis of the service provided from the first network 200A.

For example, in a case where the paging cause information is received, the NAS processor 132 may determine which of communication with the first network 200A and communication with the second network 200B corresponding to paging is prioritized on the basis of the paging cause indicated by the paging cause information.

In a case where it is determined that communication with the first network 200A is prioritized over communication with the second network 200B, the NAS processor 132 executes processing in step S104. On the other hand, in a case where the NAS processor 132 determines that communication with the second network 200B is prioritized over communication with the first network 200A, for example, the controller 130 may perform control for transitioning from the RRC connected state to the RRC idle state or the RRC inactive state in the first network 200A without performing the processing of step S104. The controller 130 may establish an RRC connection with the second network 200B and communicate with the second network 200B.

Step S104:

The NAS processor 132 performs control to transmit a switching notification (long time switch) to the first network 200A. In the present operation example, the NAS processor 132 transmits a switching notification to an AMF 211A by a NAS message. The AMF 211A receives the switching notification from the UE 100.

The switching notification is a notification indicating that temporarily leaving the first network 200A in order to switch communication from the first network to the second network. More specifically, the switching notification is a notification indicating transition (that is, leaving) from the RRC connected state in the first network.

The switching notification may be referred to as an inactive switching notification in a case where the notification indicates that transition from the RRC connected state to the RRC inactive state is expected in the first network 200A. Thus, the inactive switching notification is, for example, a switching notification including information (RRC_INACTIVE expectation) indicating that transition from the RRC connected state to the RRC inactive state is expected in the first network 200A. In the present operation example, the NAS processor 132 transmits an inactive switching notification as the switching notification.

Note that the switching notification may be referred to as an idle switching notification in a case where the notification indicates that transition from the RRC connected state to the RRC idle state is expected in the first network 200A. Thus, the idle switching notification is, for example, a switching notification including information (RRC_IDLE expectation) indicating that transition from the RRC connected state to the RRC idle state is expected in the first network 200A.

For example, the NAS processor 132 may determine whether to expect transition to the RRC inactive state or transition to the RRC idle state on the basis of at least one of the service provided from the first network 200A or the paging cause information (paging cause).

Step S105:

The NAS processor 132 starts the reception timer. The NAS processor 132 starts the reception timer in response to transmission of the inactive switching notification in step S104.

The NAS processor 132 stores the reception timer. The reception timer is a timer that clocks a designated period after the inactive switching notification has been transmitted to the first network 200A. Thus, the reception timer expires after a designated period has elapsed. The operation of the UE 100 in a case where the reception timer expires will be described later. In the present operation example, the NAS processor 132 stores the reception timer.

The NAS processor 132 may receive a timer value indicating a designated period to be set in the reception timer from the first network 200A. For example, the NAS processor 132 may receive the timer value from the AMF 211A. The NAS processor 132 may receive the timer value, for example, in registration procedure for registering the UE 100 to the first network 200A and/or registration update procedure for updating registration in the first network 200A.

Step S106:

The AMF 211A transmits a switching notification response (long time switch response), which is a response to the switching notification, to the UE 100. The NAS processor 132 receives the switching notification response from the AMF 211A. In the present operation example, the switching notification response is transmitted by the NAS message.

The NAS processor 132 may execute processing of step S107 in response to reception of the switching notification response.

Step S107:

The NAS processor 132 stops the reception timer.

Step S108:

The AMF 211A transmits an RRC release instruction (RRCRelease instruction) to the base station 210A. The network communicator 213 of the base station 210A receives the RRC release instruction from the AMF 211A.

The RRC release instruction is an instruction for releasing the RRC connection of the UE 100.

Step S109:

The base station 210A transmits an RRC release message (RRCRelease) to the UE 100. The communicator 120 (RRC processor 131) of the UE 100 receives the RRC release message from the base station 210A.

The RRC release message may include configuration information (suspendConfig) necessary for transition to the RRC inactive state.

Step S110:

The RRC processor 131 performs control to transition from an RRC connected state to an RRC inactive state in the first network 200A. The RRC processor 131 performs control to transition to the RRC inactive state on the basis of the configuration information. In a case where the switching notification response is received before the reception timer expires, the RRC processor 131 can perform control to transition to the RRC inactive state.

Step S111:

The RRC processor 131 provides an inactive transition complete notification to the NAS processor 132 in response to the transition to the RRC inactive state in the first network 200A. The NAS processor 132 receives the inactive transition complete notification from the RRC processor 131.

The inactive transition complete notification is for notifying that the transition to the RRC inactive state is completed. In response to reception of the inactive transition complete notification, the NAS processor 132 grasps that the transition to the RRC inactive state has been completed in the first network 200A. The NAS processor 132 executes processing of step S112 in response to completion of the transition to the RRC inactive state in the first network 200A.

Step S112:

The NAS processor 132 provides an RRC connection instruction to the RRC processor 131. The RRC processor 131 receives the RRC connection instruction from the NAS processor 132.

A RRC connection instruction is an instruction to start establishment of the RRC connection in the second network 200B. The NAS processor 132 can provide the RRC connection instruction to the RRC processor 131 in response to reception of the inactive transition complete notification. The RRC processor 131 starts processing of step S113 in response to reception of the RRC connection instruction.

Step S113:

The RRC processor 131 performs processing for starting an RRC connection with the base station 210B. The RRC processor 131 executes, for example, RRC setup procedure (Setup) or RRC reestablishment procedure (Reestablishment).

Step S114:

The RRC processor 131 provides an RRC switching complete notification to the NAS processor 132 in response to establishment of the RRC connection with the base station 210B. The NAS processor 132 receives the RRC switching complete notification from the RRC processor 131.

The RRC switching complete notification is a notification indicating that establishment of the RRC connection is completed in the second network 200B. The RRC switching complete notification may be a notification indicating that transition to the RRC connected state is completed in the second network 200B.

Step S115:

The NAS processor 132 starts processing for performing communication corresponding to the paging message in the second network 200B.

### (2) Second Operation Example

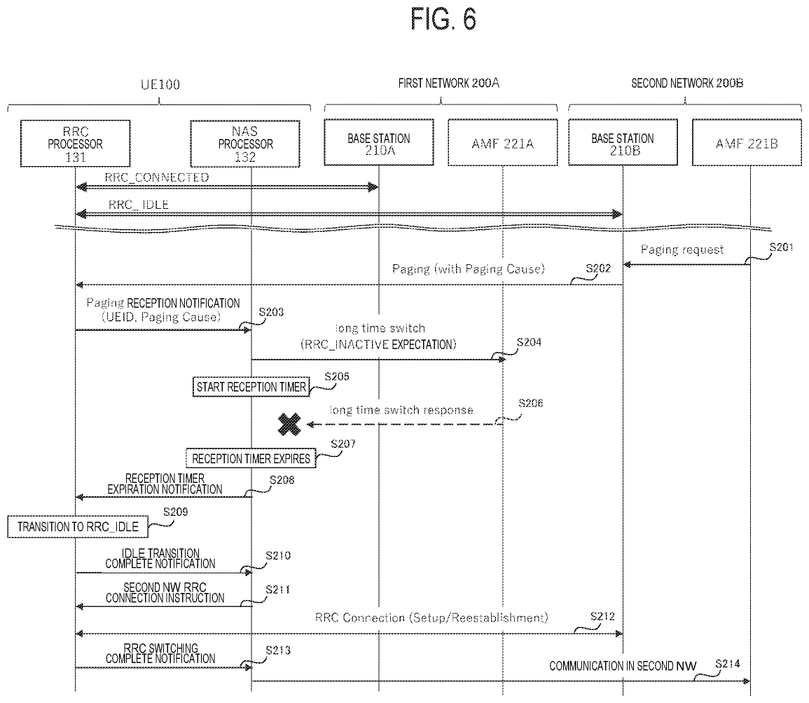

With reference to FIG. 6, a second operation example will be described focusing on differences from the above-described operation example. In the second operation example, a case in which the UE 100 does not receive the response to the switching notification before the reception timer expires will be described.

Steps S201 to S205:

These are similar to steps S101 to S105.

Step S206:

Similarly to step S106, the AMF 211A transmits a switching notification response (long time switch response), which is a response to the switching notification, to the UE 100, but the UE 100 cannot receive the switching notification response.

Step S207:

When a designated period has elapsed since the switching notification had been transmitted, the reception timer expires.

Step S208:

The NAS processor 132 provides a reception timer expiration notification to the RRC processor 131 in response to the expiration of the reception timer. The RRC processor 131 receives the reception timer expiration notification from the NAS processor 132.

The reception timer expiration notification is a notification indicating that the reception timer expires. The reception timer expiration notification may be a notification for starting transition to the RRC idle state.

Step S209:

In response to reception of the reception timer expiration notification, the RRC processor 131 performs control to transition from the RRC connected state to the RRC idle state in the first network 200A. Thus, in a case where the controller 130 of the UE 100 does not receive the inactive switching notification response from the first network 200A within a designated period after the inactive switching notification has been transmitted to the first network 200A in response to reception of the paging message, the controller 130 performs control to transition from the RRC connected state to the RRC idle state in the first network 200A. More specifically, in a case where the controller 130 does not receive the inactive switching notification response from the first network 200A until the reception timer expires, the controller 130 performs control to transition from the RRC connected state to the RRC idle state in the first network 200A.

Step S210:

The RRC processor 131 provides an idle transition complete notification to the NAS processor 132 in response to transition to the RRC idle state in the first network 200A. The NAS processor 132 receives the idle transition complete notification from the RRC processor 131.

The idle transition complete notification is for notifying that the transition to the RRC idle state is completed. In response to reception of the idle transition complete notification, the NAS processor 132 grasps that the transition to the RRC idle state has been completed in the first network 200A. The NAS processor 132 executes processing of step S211 in response to completion of the transition to the RRC idle state in the first network 200A.

Steps S211 to S214:

These are similar to steps S112 to S115.

### (3) Third Operation Example

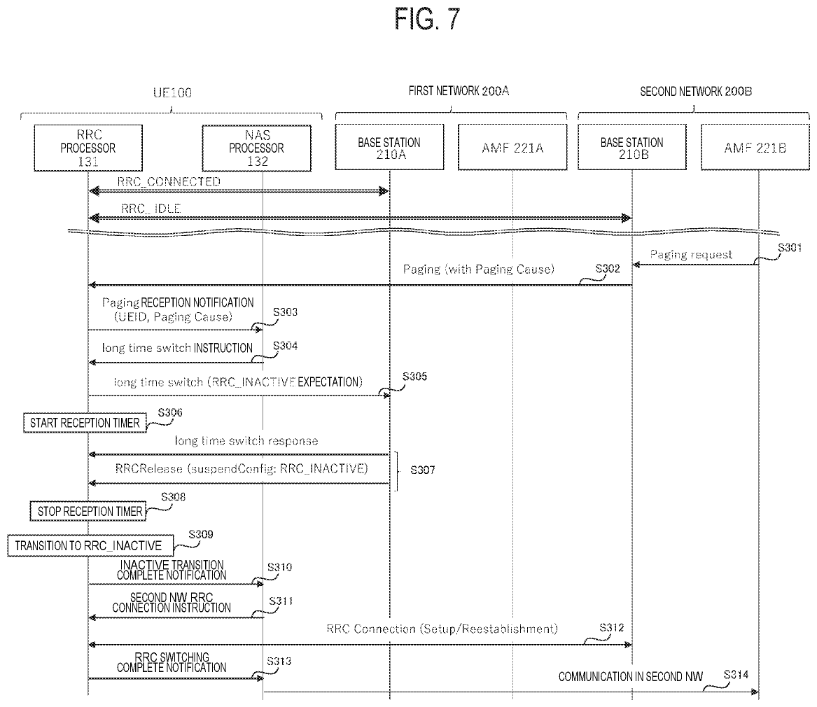

With reference to FIG. 7, a third operation example will be described focusing on differences from the above-described operation examples. The third operation example is a case where the RRC processor 131 stores the reception timer and transmits the switching notification. In addition, the third operation example is a case where the UE 100 receives a response to the switching notification before the reception timer expires.

Steps S301 to S303:

These are similar to steps S101 to S103.

Step S304:

The NAS processor 132 provides a switching notification instruction (long time switch instruction) to the RRC processor 131. The RRC processor 131 receives the switching notification instruction from the NAS processor 132.

The switching notification instruction instructs the RRC processor 131 to transmit the switching notification. The switching notification instruction may be an instruction for transmitting an inactive switching notification or may be an instruction for transmitting an idle switching notification. In a case where transition to the RRC inactive state is expected, the NAS processor 132 may issue an instruction for transmitting an inactive switching notification. In a case where transition to the RRC idle state is expected, the NAS processor 132 may issue an instruction for transmitting an idle switching notification.

As described in step S104, the NAS processor 132 may determine whether to expect transition to the RRC inactive state or transition to the RRC idle state on the basis of at least one of the service provided from the first network 200A or the paging cause information (paging cause).

Step S305:

The RRC processor 131 performs control to transmit a switching notification to the first network 200A. In the present operation example, the RRC processor 131 transmits the switching notification to the base station 210A by an RRC message. The base station 210A receives the switching notification from the UE 100.

Step S306:

The RRC processor 131 starts the reception timer. The RRC processor 131 starts the reception timer in response to transmission of the inactive switching notification in step S305.

The RRC processor 131 may receive a timer value indicating a designated period to be set in the reception timer from the first network 200A. For example, the RRC processor 131 may receive the timer value from the base station 210A. The RRC processor 131 may receive the timer value by, for example, an RRC reconfiguration message.

Step S307:

The base station 210A transmits a switching notification response to the UE 100. The RRC processor 131 receives the switching notification response from the base station 210A. In the present operation example, the switching notification response is transmitted by the RRC message.

In addition, the base station 210A transmits an RRC release message to the UE 100. The communicator 120 (RRC processor 131) of the UE 100 receives the RRC release message from the base station 210A. The RRC release message may include configuration information necessary for transitioning to the RRC inactive state.

Note that while the base station 210A separately transmits the switching notification response and the RRC release message, the present disclosure is not limited thereto. For example, the base station 210A may transmit the RRC release message as the switching notification response.

Step S308:

The RRC processor 131 stops the reception timer. The RRC processor 131 may stop the reception timer in response to reception of the switching notification response or the RRC release message.

Furthermore, the RRC processor 131 may execute processing of step S309 in response to stop of the reception timer or reception of the RRC release message.

Steps S309 to S314:

These are similar to steps S110 to S115.

### (4) Fourth Operation Example

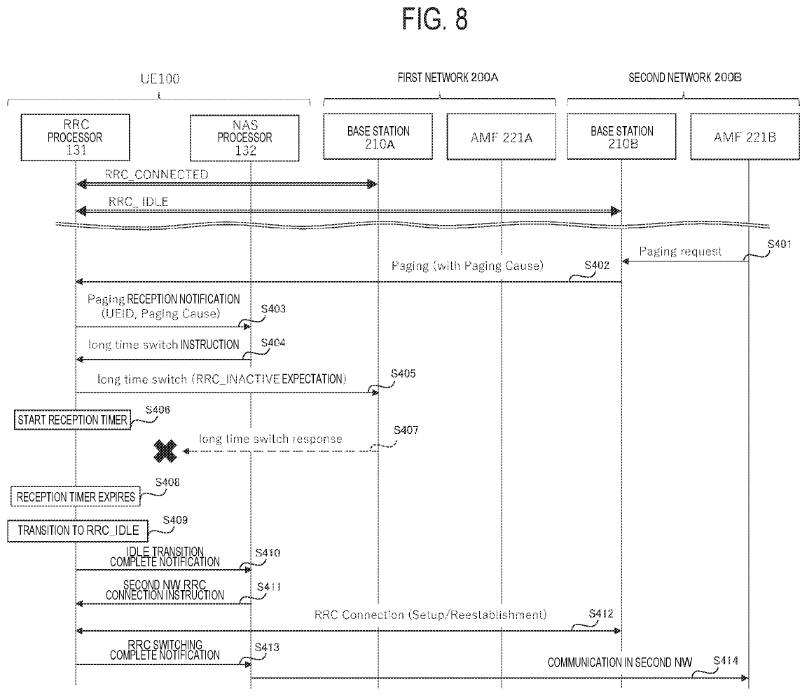

With reference to FIG. 8, a fourth operation example will be described focusing on differences from the above-described operation examples. In the fourth operation example, similarly to the third operation example, the RRC processor 131 stores the reception timer and transmits the switching notification. In addition, in the fourth operation example, a case in which the UE 100 does not receive a response to the switching notification before the reception timer expires will be described.

Steps S401 to S406:

These are similar to steps S101 to S105.

Step S407:

Similarly to step S307, the base station 210A transmits the switching notification response to the UE 100, but the UE 100 cannot receive the switching notification response. Although the base station 210A transmits the RRC release message to the UE 100, the UE 100 may not be able to receive the RRC release message.

Step S408:

When a designated period has elapsed since the switching notification had been transmitted, the reception timer expires.

Step S409:

The RRC processor 131 performs control to transition from the RRC connected state to the RRC idle state in the first network 200A in response to expiration of the reception timer.

Steps S410 to S414:

These are similar to steps S210 to S214.

### (5) Fifth Operation Example

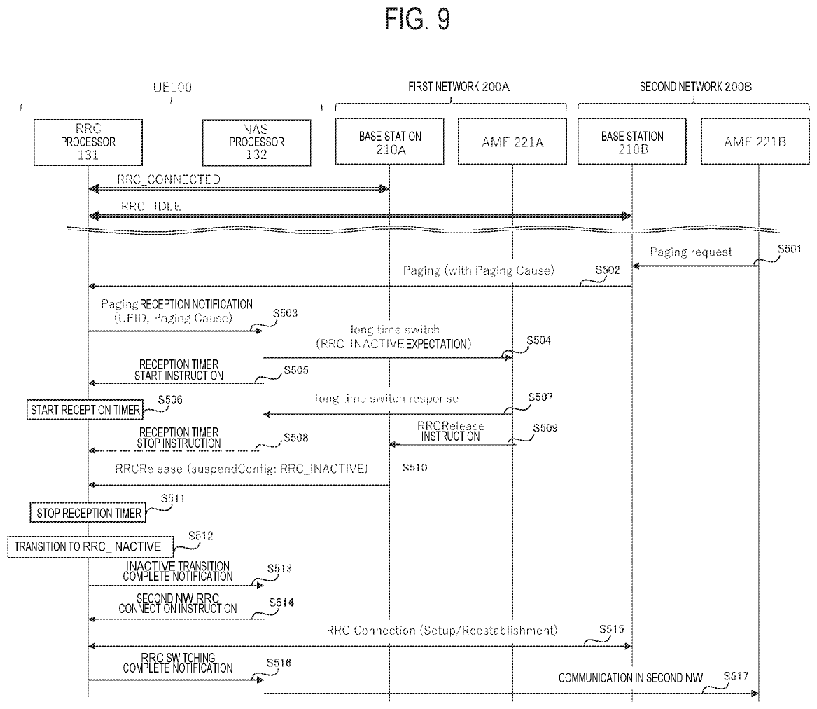

With reference to FIG. 9, a fifth operation example will be described focusing on differences from the above-described operation examples. The fifth operation example is a case where the NAS processor 132 transmits the switching notification while the RRC processor 131 stores the reception timer. In addition, the third operation example is a case where the UE 100 receives a response to the switching notification before the reception timer expires.

Steps S501 to S504:

These are similar to steps S101 to S104.

Step S505:

The NAS processor 132 provides a reception timer start instruction to the RRC processor 131. The RRC processor 131 receives the reception timer start instruction from the NAS processor 132. The NAS processor 132 provides the reception timer start instruction in response to transmission of the inactive switching notification.

The reception timer start instruction is an instruction for starting the reception timer. The reception timer start instruction may include a timer value indicating a designated period to be set in the reception timer.

Step S506:

The RRC processor 131 starts the reception timer. The RRC processor 131 starts the reception timer in response to reception of the reception timer start instruction.

Step S507:

This step is similar to step S106.

Step S508:

The NAS processor 132 may provide a reception timer stop instruction to the RRC processor 131. The RRC processor 131 may receive the reception timer stop instruction from the NAS processor 132. The NAS processor 132 can provide the reception timer stop instruction in response to reception of the switching notification response. The reception timer stop instruction is an instruction for stopping the reception timer.

Steps S509 and S510:

These are similar to steps S108 and S109.

Step S511:

The RRC processor 131 stops the reception timer. The RRC processor 131 may stop the reception timer in response to reception of the reception timer stop instruction or may stop the reception timer in response to reception of the RRC release message.

Furthermore, the RRC processor 131 may execute processing of step S512 in response to stop of the reception timer or reception of the RRC release message.

Steps S512 to S517:

These are similar to steps S110 to S115.

### (6) Sixth Operation Example

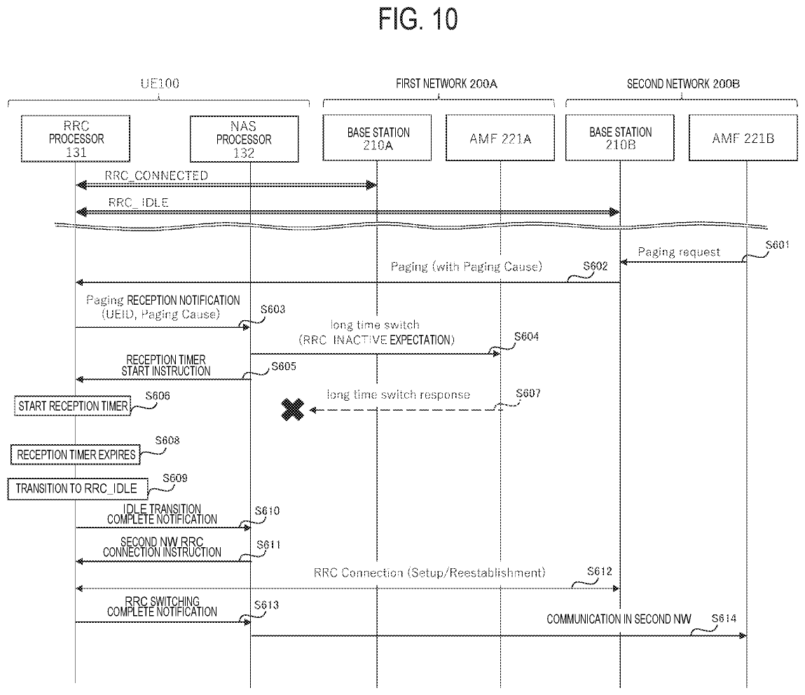

With reference to FIG. 10, a sixth operation example will be described focusing on differences from the above-described operation examples. In the sixth operation example, similarly to the fifth operation example, the RRC processor 131 stores the reception timer, and the NAS processor 132 transmits the switching notification. In addition, in the sixth operation example, a case in which the UE 100 does not receive a response to the switching notification before the reception timer expires will be described.

Steps S601 to S606:

These are similar to steps S501 to S505.

Step S607:

Similarly to step S206, the AMF 211A transmits the switching notification response, which is a response to the switching notification, to the UE 100, but the UE 100 cannot receive the switching notification response.

Steps S608 to S614:

These are similar to steps S408 to S414.

### (7) Seventh Operation Example

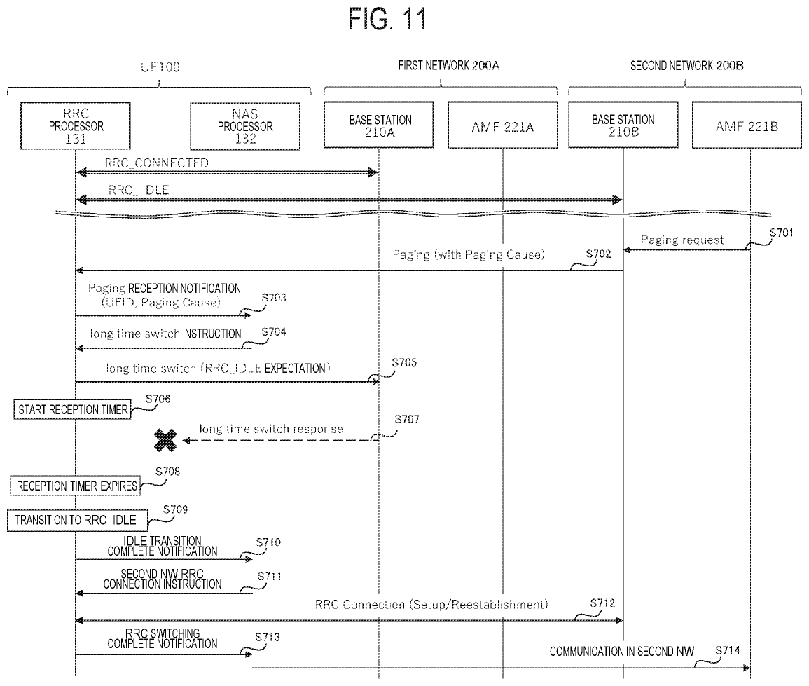

With reference to FIG. 11, a seventh operation example will be described focusing on differences from the above-described operation examples. The seventh operation example is a case where an idle switching notification is transmitted.

Steps S701 to S704:

These are similar to steps S401 to S404.

Step S705:

The RRC processor 131 performs control to transmit an idle switching notification to the first network 200A.

Step S706:

The RRC processor 131 starts the reception timer. The reception timer may be the same as the reception timer to be used in a case where the inactive switching notification is transmitted. Thus, the timer value set in the reception timer, that is, the designated period from start to expiration of the reception timer may be the same in a case where the inactive switching notification is transmitted and a case where the idle switching notification is transmitted.

Alternatively, the reception timer may be different from the reception timer to be used in a case where the inactive switching notification is transmitted. Thus, the timer value set in the reception timer, that is, the designated period from start to expiration of the reception timer may be different between a case where the inactive switching notification is transmitted and a case where the idle switching notification is transmitted.

For example, the timer value of the reception timer (hereinafter, a first reception timer) to be used in a case where the inactive switching notification is transmitted may be longer than the timer value of the reception timer (hereinafter, a second reception timer) to be used in a case where the idle switching notification is transmitted. As a result, a period for the UE 100 to wait for the response of the inactive switching notification becomes long, and thus, it becomes easy to receive the response. As a result, the UE 100 can be easily put into the RRC inactive state in which the procedure for starting the communication with the first network can be simplified after the end of the communication with the second network.

The timer value of the first reception timer may be shorter than the timer value of the second reception timer. As a result, as compared with a case where the timer value of the first reception timer is longer than the timer value of the second reception timer, in a case where the response of the inactive switching notification cannot be received, communication with the second network 200B prioritized over communication with the first network 200A can be started earlier.

Steps S707 and S708:

These are similar to steps S407 and S408.

Step S709:

In response to reception of the reception timer expiration notification, the RRC processor 131 performs control to transition from the RRC connected state to the RRC idle state in the first network 200A. Thus, in a case where a response to the idle switching notification is not received from the first network 200A within a designated period after the idle switching notification has been transmitted to the first network 200A in response to reception of the paging message, the controller 130 of the UE 100 performs control to transition from the RRC connected state to the RRC idle state in the first network 200A.

Note that the RRC processor 131 performs control to transition from the RRC connected state to the RRC idle state in the first network 200A in a case where a response to the idle switching notification or the RRC release message is received from the first network 200A within the designated period.

Steps S710 to S714:

These are similar to steps S410 to S414.

### Other Embodiments

In the above-described embodiment, the switching notification of each operation example may be referred to as a long time switch or may be another name. The switching notification may be, for example, a message or an information element to be used in switching procedure for leaving the RRC connected state (switching procedure for leaving RRC_CONNECTED state).

In the above-described embodiment, the timer value may be stored in the UE 100 in advance. Thus, the UE 100 does not have to receive the timer value from the first network 200A.

The steps in the operation of the above-described embodiment may not necessarily be performed in chronological order according to the order described in the flow diagram or sequence diagram. For example, the steps in the operation may be performed in an order different from the order described as the flow diagram or sequence diagram, or may be performed in parallel. In addition, some of the steps in the operation may be removed and additional steps may be added to the processing. Furthermore, each operation flow described above is not necessarily implemented separately and independently and a combination of two or more operation flows can be implemented. For example, some steps of one operation flow may be added to another operation flow, or some steps of one operation flow may be replaced with some steps of another operation flow.

A program may be provided for causing a computer to execute each processing to be performed by the UE 100 or the base station 210. The program may be recorded on a computer readable medium. By using the computer readable medium, the program can be installed in the computer. Here, the computer readable medium on which the program is recorded may be a non-transitory recording medium. The non-transitory recording medium is not particularly limited to, but may be, for example, a recording medium such as a CD-ROM (Compact Disk Read Only Memory) or a DVD-ROM (Digital Versatile Disc Read Only Memory). Furthermore, a circuit that executes each processing to be performed by the UE 100 or the base station 210 may be integrated, and at least a part of the UE 100 or the base station 210 may be configured as a semiconductor integrated circuit (chipset, SoC (system-on-chip)).

Note that, in the above-described embodiment, “transmit” may mean to perform processing of at least one layer in a protocol stack used for transmission, or may mean to physically transmit a signal wirelessly or by wire. Alternatively, “transmit” may mean a combination of performing the processing of at least one layer and physically transmitting a signal wirelessly or by wire. Similarly, “receive” may mean to perform processing of at least one layer in a protocol stack used for reception, or may mean to physically receive a signal wirelessly or by wire. Alternatively, “receive” may mean a combination of performing the processing of at least one layer and physically receiving a signal wirelessly or by wire.

Although the present disclosure has been described in accordance with examples, it is understood that the present disclosure is not limited to the examples and structures. The present disclosure also includes various modifications and modifications within an equivalent range. In addition, various combinations and modes, and other combinations and modes including only one element, more elements, or less elements are also within the scope and idea of the present disclosure.

1. A communication apparatus configured to communicate with a plurality of networks including a first network and a second network by using a plurality of subscriber identity modules, the communication apparatus comprising:
a receiver configured to receive, from a base station of the first network, a radio resource control (RRC) reconfiguration message including first information configuring a timer value for controlling of transition to an RRC idle state; and
a controller configured to
perform the transition to the RRC idle state, in a case that second information indicating the RRC idle state is transmitted to the base station of the first network for leaving an RRC connected state and that a timer of the timer value configured based on the first information expires, and
perform the transition to the RRC idle state, in a case that third information indicating an RRC inactive state is transmitted to the base station of the first network for leaving the RRC connected state and that the timer of the timer value configured based on the first information expires.

2. The communication apparatus according to claim 1, wherein
the controller is configured to
start the timer of the timer value in a case that the second information indicating the RRC idle state is transmitted to the base station of the first network for leaving the RRC connected state,
start the timer of the timer value in a case that the third information indicating the RRC inactive state is transmitted to the base station of the first network for leaving the RRC connected state, and
stop the timer of the timer value in a case that an RRC release message is received from the base station of the first network.

3. The communication apparatus according to claim 1, wherein
the controller includes an RRC processor and a Non-Access Stratum (NAS) processor, and
the RRC processor is configured to notify the NAS processor of that the transition to the RRC idle state is performed.

4. Abase station of a first network configured to communicate with a communication apparatus configured to communicate with a plurality of networks including the first network and a second network by using a plurality of subscriber identity modules, the base station comprising:
a transmitter configured to transmit, to the communication apparatus, a radio resource control (RRC) reconfiguration message including first information configuring a timer value for controlling of transition to an RRC idle state; and
a receiver configured to
receive, from the communication apparatus, second information indicating the RRC idle state in a case that the communication apparatus is leaving an RRC connected state, and
receive, from the communication apparatus, third information indicating the RRC idle state in a case that the communication apparatus is leaving the RRC connected state, wherein
the transition to the RRC idle state is performed by the communication apparatus, in a case that the second information indicating the RRC idle state is received and that a timer of the timer value configured based on the first information expires, and
the transition to the RRC idle state is performed by the communication apparatus, in a case that the third information indicating an RRC inactive state is received and that a timer of the timer value configured based on the first information expires.

5. The base station according to claim 4, further comprising
a controller configured to
start the timer of the timer value in a case that the second information indicating the RRC idle state is received,
start the timer of the timer value in a case that the third information indicating the RRC inactive state is received, and
stop the timer of the timer value in a case that an RRC release message is transmitted to the communication apparatus.

6. A communication method executed by a communication apparatus configured to communicate with a plurality of networks including a first network and a second network by using a plurality of subscriber identity modules, the communication method comprising the steps of:
receiving, from a base station of the first network, a radio resource control (RRC) reconfiguration message including first information configuring a timer value for controlling of transition to an RRC idle state,
performing the transition to the RRC idle state, in a case that second information indicating the RRC idle state is transmitted to the base station of the first network for leaving an RRC connected state and that a timer of the timer value configured based on the first information expires, and
performing the transition to the RRC idle state, in a case that third information indicating the RRC inactive state is transmitted to the base station of the first network for leaving an RRC connected state and that the timer of the timer value configured based on the first information expires.

7. The communication method according to claim 6, further comprising the steps of:
starting the timer of the timer value in a case that the second information indicating the RRC idle state is transmitted to the base station of the first network for leaving the RRC connected state,
starting the timer of the timer value in a case that the third information indicating the RRC inactive state is transmitted to the base station of the first network for leaving the RRC connected state, and
stopping the timer of the timer value in a case that an RRC release message is received from the base station of the first network.

8. The communication method according to claim 6, further comprising the steps of:
notifying from an RRC processor to a Non-Access Stratum (NAS) processor of that the transition to the RRC idle state is performed.
